(19) United States
(12) Patent Application Publication
(10) Pub. No.: US 2013/0097106 A1
(43) Pub. Date: Apr. 18, 2013

(54) APPARATUS AND METHOD FOR EXTENDING A DEFAULT MODEL OF A TERMINAL

(71) Applicant: Sang-do Park, Seoul (KR)

(72) Inventor: Sang-do Park, Seoul (KR)

(21) Appl. No.: 13/563,326

(22) Filed: Jul. 31, 2012

(30) Foreign Application Priority Data
Oct. 12, 2011 (KR) 10-2011-0104241

(51) Int. Cl. G06F 15/18

(52) U.S. Cl. 706/12

(57) ABSTRACT

Provided are an apparatus and method for extending a default model of a terminal. The apparatus may extend a default model of the terminal using an extension model relating to the default model and using linked data.

### CROSS-REFERENCE TO RELATED APPLICATION(S)

This application claims the benefit under 35 U.S.C. §119(a) of a Korean Patent Application No. 10-2011-0104241, filed on Oct. 12, 2011, in the Korean Intellectual Property Office, the entire disclosure of which is incorporated herein by reference for all purposes.

### BACKGROUND

1. Field

The following description relates to technology for extending a default model stored in a terminal using, for example, another model or data.

2. Description of the Related Art

Situation awareness involves being aware of what is happening or what is going to happen in a nearby vicinity to understand how information, events, and one's own actions will impact goals and objectives, both immediately and in the near future. A reasoning or inference engine may use situation awareness technology.

Context-aware technology that includes a reasoning engine may utilize a model to infer context. One type of model is an ontology. The results of the inference may vary based on how specifically a model is defined. For example, the more specifically defined a model is, the more precise of an inference is possible. For this reason, context-aware technology limited to a specific domain has been researched.

However, recent terminals provide a context-aware service that is not for a specific domain but for a plurality of various domains. To provide such a context-aware service for various domains, a variety of models corresponding to the respective domains are needed. As an example, if a user of a terminal is in a theater, a “theater” model is needed to recognize context relating to the theater. As another example, if a user of a terminal meets his/her friend, a “friend” model is needed to recognize context relating to the friend. However, it is very difficult for a terminal to generate, store, provide, and manage various models for each and every domain.

Typically a default model is stored in a terminal. However, due to heterogeneity between a default model and linked data/linked data model, it is not possible to extend the conventional default model. The heterogeneity is caused because the same context can be defined in various ways. Thus, there is a desire to extend a default model of a terminal.

### SUMMARY

In one general aspect, there is provided an apparatus for extending a default model of a terminal, the apparatus including a first extractor configured to extract an extension model corresponding to the default model, based on user context information, a second extractor configured to extract linked data relating to the extension model, and a combiner configured to combine the extension model, the linked data, and the default model.

The extension model may be classified according to domain, and the first extractor may be further configured to determine a domain based on the user context information and extract the extension model based on the determined domain.

The extension model may be in a form that is capable of being combined with the default model.

A linked data set may be linked to the extension model, and the second extractor is further configured to extract the linked data from the linked data set.

The second extractor may be further configured to extract a keyword from the user context information, and extract the linked data using the extracted keyword and a linked-data search engine.

The apparatus may further comprise an internal memory to store the extension model, and an update unit configured to obtain a new extension model from an external storage device, and add the obtained new extension model to the internal memory.

In another aspect, there is provided a method of extending a default model of a terminal, the method including extracting an extension model corresponding to a default model, based on user context information, extracting linked data relating to the extension model, and combining the extension model and the linked data with the default model.

The extracting of the extension model may comprise, in response to the extension model being classified according to domain, determining a domain based on the user context information, and extracting the extension model corresponding to the default model based on the determined domain.

The extension model may be in a form that is capable of being combined with the default model.

The extracting the linked data may comprise, in response to a linked data set being linked to the extension model, extracting the linked data from the linked data set.

The extracting the linked data may comprise extracting a keyword from the user context information, and extracting the linked data using the extracted keyword and a linked-data search engine.

The method may further comprise obtaining a new extension model from an external storage device, and adding the obtained new extension model to an internal memory in which the extension model is stored.

In another aspect, there is provided a computer-readable storage medium storing program instructions to cause a computer to execute a method of extending a default model of a terminal, the method including extracting an extension model corresponding to a default model, based on user context information, extracting linked data relating to the extension model, and combining the extension model and the linked data with the default model.

In another aspect, there is provided an apparatus for extending a default model of a terminal to provide a user of the terminal with context-aware information, the apparatus including an extractor configured to determine a domain of the user of the terminal based on context information about the user, and to extract an extension model based on the determined domain, and a combiner configured to combine the default model and the extension model to generate an extended default model of the terminal.

The extractor may be configured to extract the extension model without performing a matching process.

The extractor may be further configured to extract a linked data set that is linked to the extension model, and the combiner may be further configured to combine the linked data set and the extension model, with the default model to generate the extended default model of the terminal.

The extractor may be configured to extract the linked data set without performing a matching process.

Other features and aspects will be apparent from the following detailed description, the drawings, and the claims.

### BRIEF DESCRIPTION OF THE DRAWINGS

FIG. 1 is a diagram illustrating an example of an apparatus for extending a default model of a terminal.

FIG. 2 is a table illustrating an example of extension models classified according to domain.

FIG. 3 is a diagram illustrating another example of an apparatus for extending a default model of a terminal.

FIG. 4 is a diagram illustrating another example of an apparatus for extending a default model of a terminal.

FIG. 5 is a diagram illustrating an example of a process in which a default model is extended.

FIG. 6 is a flowchart illustrating an example of a default model extending method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

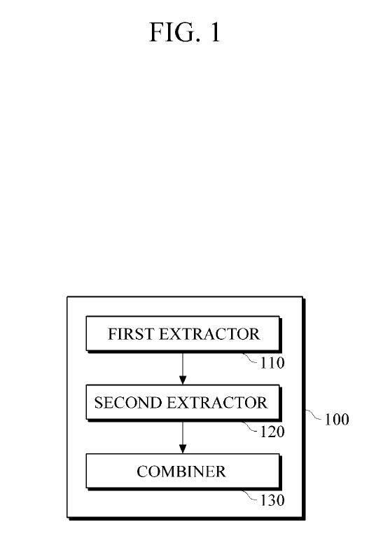

FIG. 1 illustrates an example of an apparatus for extending a default model of a terminal.

Referring to FIG. 1, default model extending apparatus 100 includes a first extractor 110, a second extractor 120, and a combiner 130. The term “default” as used herein is not meant to limit the type of model that may be extended. It should be understood that a model used for context reasoning may be extended by the examples described herein.

The default model extending apparatus 100 may be included in a terminal. For example, the terminal may be a device such as a cellular phone, a smart phone, a laptop computer, a digital broadcast terminal, a personal digital assistant (PDA), a portable multimedia player (PMP), and a navigation device, a tablet, and the like, which are capable of storing or executing a context-aware application.

The first extractor 110 may extract an extension model corresponding to a default model based on user context information. For example, the user context information may include any type of context such as a current location of the user/terminal, information included in a telephone conversation of the user, messages transmitted and received by the user, emails transmitted and received by the user, hobbies of the user, a consumption propensity of the user, a past behavior pattern of the user, and the like. The user context information may be extracted by an apparatus, for example, a location device, an email server, a communication server, a terminal capable of storing or transmitting and receiving user context information, and the like.

As described herein, a model includes various concepts for describing a domain. The concepts are connected with each other in semantic relations. A concept may be expressed as a class.

As described herein, a default model represents a first model. A default model may be stored when a terminal manufacturer, etc. manufactures a terminal. For example, a default model may generally include upper-level concepts such as a location, time, and companion. Manufacturers may open default models to the public. As another example, a default model may be installed subsequently by a user of a terminal. For example, a user may download the default model via a network.

An extension model may be combined with a default model of a terminal, and also with linked data. An extension model may be added by a user, model designer, update device, automatically added by the terminal, and the like. For example, an extension model may include at least one of the concepts included in a default model. Linked data may include data corresponding to a concept of an extension model or a model including the concept included in the extension model.

For example, extension models A, B, and C may be combined with a default model D. If a model relating to the user context information is the default model D, the first extractor 110 may directly extract extension models A, B, and C corresponding to default model D without performing an additional process such as matching. If extension models are classified according to domain, the first extractor 110 may determine a domain relating to the user context information. The first extractor 110 may extract an extension model corresponding to a default model relating to the determined domain.

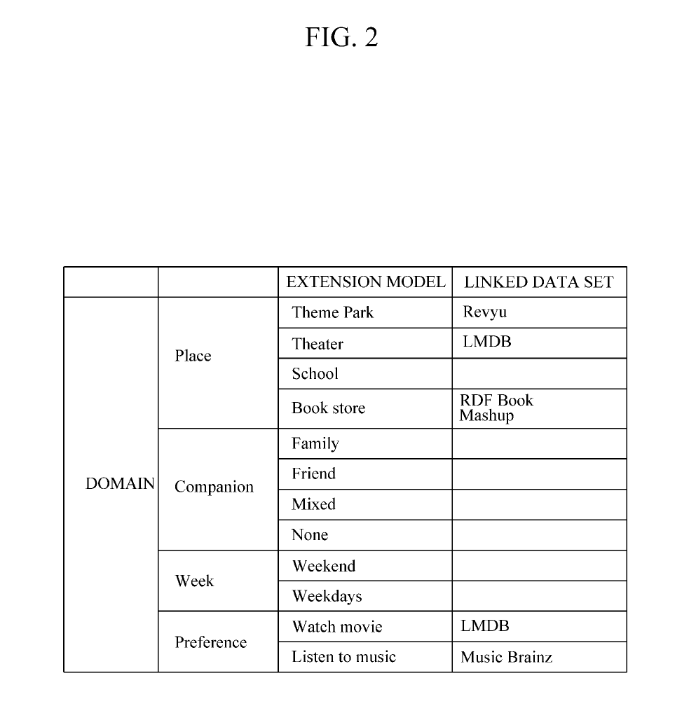

FIG. 2 illustrates an example of a table showing extension models classified according to domain.

In the example of FIG. 2, the table includes a place domain, a companion domain, a time domain, and a preference domain. However, the description herein is not limited thereto.

In this example, extension models corresponding to the place domain include a “Theme park” model, “Theater” model, “School” model, and “Book store” model. The “Theme park” model, “Theater” model, and “Book store” model may be set to connect with a “Revyu”-linked data set, an “LMDB”-linked data set, and an “RDF Book Mashup”-linked data set, respectively. A linked data set includes at least one piece of linked data. Linked data may be generated by adding a semantic relation to raw data.

Extension models corresponding to the companion domain include a “Family” model corresponding to a user together with his/her family, a “Friend” model corresponding to the user together with his/her friend, a “Mixed” model corresponding to the user together with various persons, and a “None” model in which there is no one except the user.

Extension models corresponding to the time domain may include a “Weekend” model corresponding to a weekend, and a “Weekdays” model corresponding to a weekday.

Extension models corresponding to the preference domain include a “Watch movie” model about movies the user prefers to watch, and a “Listen to music” model about music the user prefers to listen to. The “Watch movie” model and “Listen to music” model may be set to connect with a “LMDB”-linked data set and a “Music Brainz”-linked data set, respectively.

In addition to the above-mentioned examples, the extension models may be classified into various other models not specifically mentioned herein, and various linked data sets may be connected with the extension models.

For example, if the user context information is “the user is in a theater,” the first extractor 110 may determine a “theater” among places as the domain. The first extractor 110 may extract a “Theater” extension model corresponding to a default model relating to the determined “theater” domain. The “Theater” extension model relates to the “theater” domain, and has a form that may be combined with the default model relating to the “theater” domain.

The second extractor 120 may extract linked data relating to the extension model. As an example, if a linked data set has been set for the extension model, the second extractor 120 may extract linked data from the linked data set. If the linked data set for the extension model is the LMDB-linked data set, the second extractor 120 may extract linked data relating to the extension model from the LMDB-linked data set. As another example, the second extractor may extract a keyword from the user context information, and extract linked data using the extracted keyword and a linked-data search engine. For example, if the keyword is “A theme park,” the second extractor 120 may input “A theme park” to the linked-data search engine to extract linked data relating to “A theme park.”

As described herein, the first extractor 110 and the second extractor 120 may be the same component or unit, however, for convenience they are described separately. That is, the first extractor 110 and the second extractor 120 may be combined to form a single extractor.

The combiner 130 may combine the extension model extracted by the first extractor 110 and/or the linked data extracted by the second extractor 120 with the default model. As described herein, the original default model may be a model including only basic concepts for context awareness. Described herein is a method of extending the default model. A context-aware device may recognize context using a default model combined with the extension model and combined with the linked data, thereby recognizing the context more accurately than a case of recognizing context using an existing default model by itself.

The default model extending apparatus 100 may extract an extension model corresponding to a default model of a terminal and add the extension model to the default model. The default model may further extract linked data of the extension model, and add the extracted extension model and linked data to the default model, thereby extending the default model of the terminal to various models.

Also, the default model extending apparatus 100 may combine a default model with an extension model relating to the default model and linked data, thereby easily combining the heterogeneous default model and linked data using the extension model.

Further, because the default model extending apparatus 100 may extend a default model to recognize a specific situation, terminals have various forms capable of recognizing various situations and do not need to store default models of a large capacity.

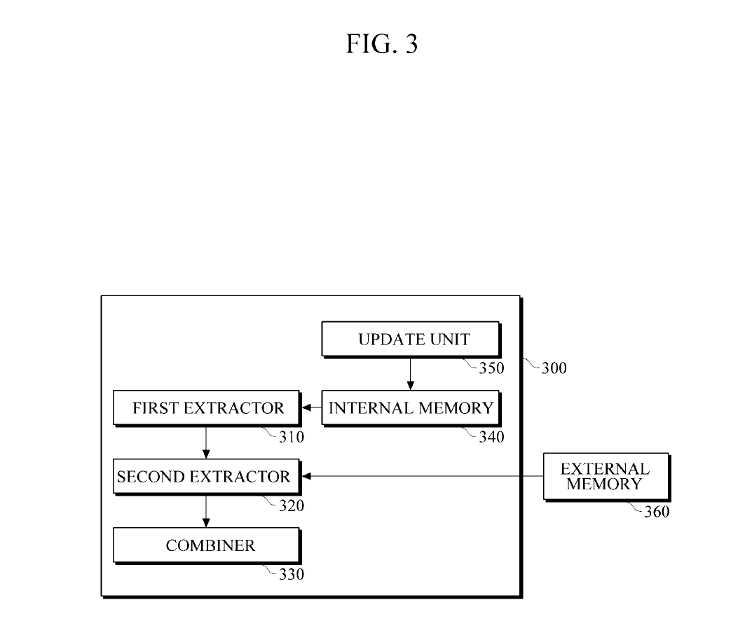

FIG. 3 illustrates another example of an apparatus for extending a default model of a terminal.

Referring to FIG. 3, default model extending apparatus 300 includes a first extractor 310, a second extractor 320, a combiner 330, an internal memory 340, and an update unit 350.

The internal memory 340 may store various extension models. An external memory 360 may be located outside the default model extending apparatus 300, and may store linked data. For example, the internal memory 340 and the external memory 360 may include at least one of a flash memory, a hard disk type memory, a multimedia card micro type memory, a card type memory (e.g., secure digital (SD) or extreme digital (XD) memory), a random-access memory, a read-only memory (ROM), a web storage, and the like.

The first extractor 310 may extract an extension model relating to user context information from the internal memory 340.

The second extractor 320 may extract linked data relating to the extension model from the external memory 360.

The combiner 330 may combine the extension model extracted by the first extractor 310 and the linked data extracted by the second extractor 320 with the default model relating to the user context information. In this example, the default model may be stored in the internal memory 340.

The update unit 350 may obtain a new extension model from external storage devices such as a universal serial bus (USB) memory, an external hard disk drive (HDD), a web storage, and the like. As an example, the update unit 350 may automatically obtain a new extension model from an external storage device at set periods. As another example, if a user stores a new extension model in an external storage device and connects the new extension model to the default model extension apparatus 300, the update unit 350 may automatically obtain the new extension model from the connected external storage device. The update unit 350 may add the new extension model to the internal memory 340.

The default model extension apparatus 300 may update extension models stored in the internal memory 340, thereby ensuring various extension models. Also, because the default model extension apparatus 300 may extend a default model to recognize a specific situation, terminals may have various forms capable of recognizing various situations and do not need to store default models of a large capacity.

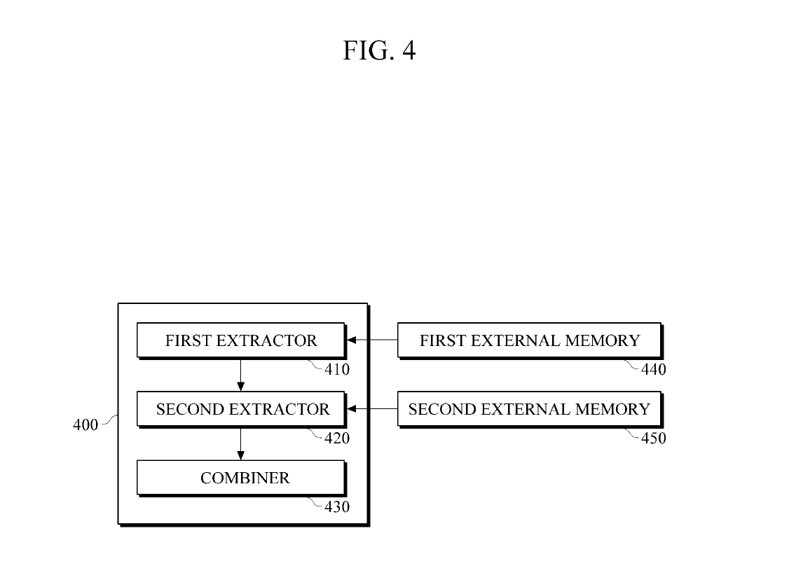

FIG. 4 illustrates another example of an apparatus for extending a default model of a terminal.

Referring to FIG. 4, default model extending apparatus 400 includes a first extractor 410, a second extractor 420, a combiner 430, a first external memory 440, and a second external memory 450.

In this example, the first external memory 440 is outside the default model extending apparatus 400, and may be used to store various extension models. For example, the first external memory 440 may be accessed by anyone. Thus, anyone can store an extension model in the first external memory 440, and various extension models may be stored in the first external memory 440. The second external memory 450 is also outside the default model extending apparatus 400, and may store linked data.

The first extractor 410 may extract an extension model corresponding to a default model relating to user context information from the first external memory 440.

The second extractor 420 may extract linked data relating to the extension model from the second external memory 450.

The combiner 430 may combine the extension model extracted by the first extractor 410 and the linked data extracted by the second extractor 420 with the default model relating to the user context information. Accordingly, by extracting an extension model from the first external memory 440 that anyone can access, the default model extending apparatus 400 can extract an extension model alone without exposing a default model to the outside, and also extract various extension models stored by various persons.

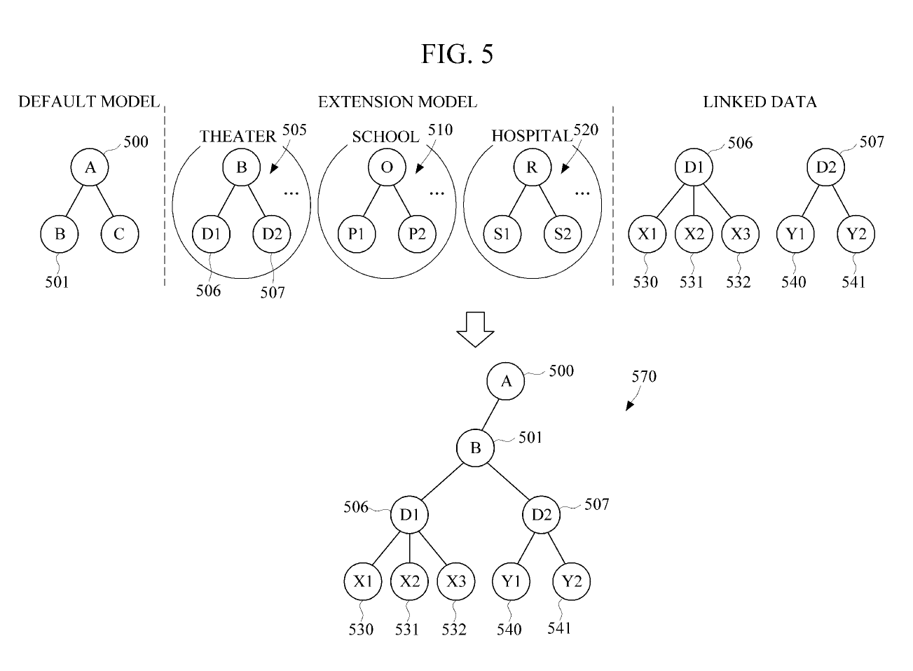

FIG. 5 illustrates an example of a process in which a default model is extended.

Referring to FIG. 5, a default model extending apparatus may determine a domain relating to user context information. For example, if the user context information is “a user is in a theater,” the default model extending apparatus may determine a domain as “theater B.” The default model extending apparatus may extract an extension model corresponding to a default model relating to the determined domain among extension models classified according to domain. For example, the default model extending apparatus may extract a “Theater” extension model 505 from among extension models 505, 510 and 520.

The “Theater” extension model 505 is a model corresponding to a concept 501 of a default model relating to a “theater” domain. The “Theater” extension model 505 may be in a form that is capable of being combined with a default model relating to the determined “theater” domain.

In this example, a case in which a model corresponding to the “theater” domain is the “Theater” extension model 505 is described for convenience, but models other than the “Theater” extension model 505 may correspond to the “theater” domain. Besides the extension models 505, 510, and 520, various other extension models may exist. In this example, the default model extending apparatus may extract pieces of linked data 530, 531, 532, 540, and 541 relating to a D1 concept 506 and a D2 concept 507 included in the theater extension model 505.

The default model extending apparatus may combine the theater extension model 505 and the pieces of linked data 530, 531, 532, 540, and 541 with the default model, thereby generating an extended default model 570. For example, the default model extending apparatus may combine the theater extension model 505 and the pieces of linked data 530, 531, 532, 540, and 541 with the concept 501 of the default model, thereby generating the extended default model 570. In this example, concept 500 of the default model is the uppermost concept.

The default model extending apparatus may extract an extension model corresponding to a default model of a terminal and linked data, and add the extracted extension model and linked data to the default model, thereby extending the default model of the terminal to various models.

Also, the default model extending apparatus may combine a default model with an extension model relating to the default model and linked data, thereby combining the heterogeneous default model and linked data using the extension model.

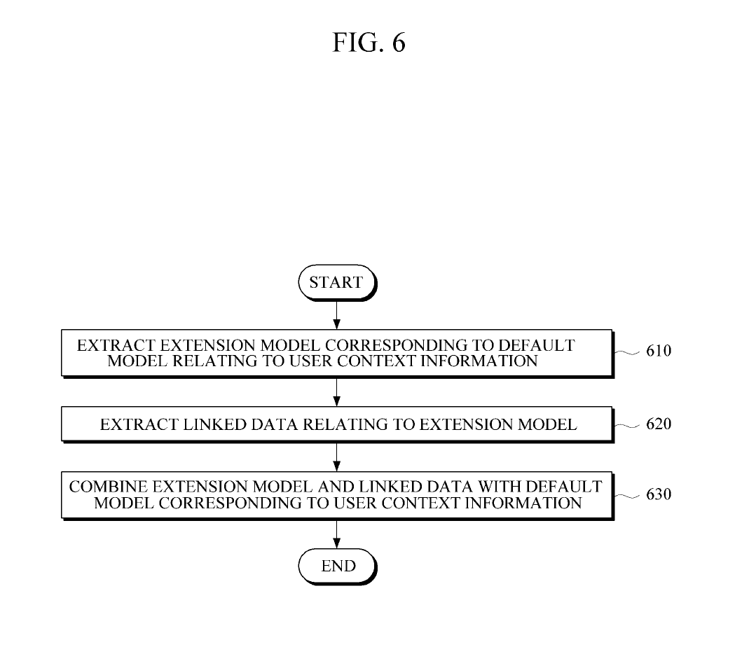

FIG. 6 illustrates an example of a default model extending method.

Referring to FIG. 6, an extension model corresponding to a default model relating to user context information is extracted in (610). For example, the extension models may be classified according to domain, and the default model extending apparatus may determine a domain relating to the user context information. The default model extending apparatus may extract an extension model corresponding to a default model relating to the determined domain.

Linked data relating to the extension model is extracted in (620). As an example, a linked data set may be set for the extension model, and the default model extending apparatus may extract linked data from the linked data set. As another example, the default model extending apparatus may extract a keyword from the user context information. The default model extending apparatus may extract linked data using the extracted keyword and a linked-data search engine.

The extension model and linked data are combined with the default model corresponding to the user context information in (630). For example, the default model extending apparatus may extract an extension model relating to a default model of a terminal and linked data, and add the extracted extension model and linked data to the default model, thereby easily extending the default model of the terminal.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for extending a default model of a terminal, the apparatus comprising:
a first extractor configured to extract an extension model corresponding to the default model, based on user context information;
a second extractor configured to extract linked data relating to the extension model; and
a combiner configured to combine the extension model, the linked data, and the default model.

2. The apparatus of claim 1, wherein the extension model is classified according to domain, and the first extractor is further configured to determine a domain based on the user context information and extract the extension model based on the determined domain.

3. The apparatus of claim 1, wherein the extension model is in a form that is capable of being combined with the default model.

4. The apparatus of claim 1, wherein a linked data set is linked to the extension model, and the second extractor is further configured to extract the linked data from the linked data set.

5. The apparatus of claim 1, wherein the second extractor is further configured to extract a keyword from the user context information, and extract the linked data using the extracted keyword and a linked-data search engine.

6. The apparatus of claim 1, further comprising:
an internal memory to store the extension model; and
an update unit configured to obtain a new extension model from an external storage device, and add the obtained new extension model to the internal memory.

7. A method of extending a default model of a terminal, the method comprising:
extracting an extension model corresponding to a default model, based on user context information;
extracting linked data relating to the extension model; and
combining the extension model and the linked data with the default model.

8. The method of claim 7, wherein extracting of the extension model comprises:
in response to the extension model being classified according to domain, determining a domain based on the user context information; and
extracting the extension model corresponding to the default model based on the determined domain.

9. The method of claim 7, wherein the extension model is in a form that is capable of being combined with the default model.

10. The method of claim 7, wherein extracting the linked data comprises, in response to a linked data being linked to the extension model, extracting the linked data from the linked data set.

11. The method of claim 7, wherein extracting the linked data comprises:
extracting a keyword from the user context information; and
extracting the linked data using the extracted keyword and a linked-data search engine.

12. The method of claim 7, further comprising:
obtaining a new extension model from an external storage device; and
adding the obtained new extension model to an internal memory in which the extension model is stored.

13. An apparatus for extending a default model of a terminal to provide a user of the terminal with context-aware information, the apparatus comprising:
an extractor configured to determine a domain of the user of the terminal based on context information about the user, and to extract an extension model based on the determined domain; and
a combiner configured to combine the default model and the extension model to generate an extended default model of the terminal.

14. The apparatus of claim 13, wherein the extractor is configured to extract the extension model without performing a matching process.

15. The apparatus of claim 13, wherein the extractor is further configured to extract a linked data set that is linked to the extension model, and
the combiner is further configured to combine the linked data set and the extension model, with the default model to generate the extended default model of the terminal.

16. The apparatus of claim 15, wherein the extractor is configured to extract the linked data set without performing a matching process.
